(19) United States
(12) Patent Application Publication
(10) Pub. No.: US 2002/0113753 A1
(43) Pub. Date: Aug. 22, 2002

(54) 3D display devices with transient light scattering shutters

(76) Inventors: Alan Sullivan, White Plains, NY (US); Sara L. Johnson, New York, NY (US)

Correspondence Address: Abraham Kasdan, Esq., Amster, Rothstein & Ebenstein, 90 Park Avenue, New York, NY, 10016, US

(21) Appl. No.: 10/026,934

(22) Filed: Dec. 18, 2001

Related U.S. Application Data
(60) Provisional application No. 60/256,382, filed on Dec. 18, 2000.

(51) Int. Cl. G02F 1/1335; G09G 5/00

(52) U.S. Cl. 345/6; 349/5

(57) ABSTRACT

A transient light scattering shutter is provided that switches very quickly from an optically transparent state to a strongly light scattering state and vice versa by varying a voltage across the shutter. Multi-surface optical devices and multiplanar volumetric systems using a plurality of such transient light scattering shutters are also provided. These devices and systems generate high quality three-dimensional images that are viewable without special eyewear or headgear.

### CROSS REFERENCE TO RELATED APPLICATION

This claims the benefit of United States Provisional Application No. 60/256,382, filed Dec. 18, 2000.

### BACKGROUND OF THE INVENTION

The present invention relates to three-dimensional (3D) display devices having liquid crystal shutters that can change very quickly from optically transparent to strongly light scattering and vice versa.

Liquid crystal shutters are electro-optic devices that are electrically switchable between a transparent state and a light scattering state by varying an electric field. Such shutters can be made from a variety of liquid crystalline preparations. Often, these liquid crystal preparations are stabilized in a polymer matrix. The polymer network formed by the matrix improves the electro-optic performance of light scattering shutters by stabilizing the texture of the liquid crystal. This aids in the return of the liquid crystal molecular orientation to the desired stable configuration and reduces the switching time between transparent and scattering states.

Polymer stabilized liquid crystal (PSLC) cells preferably used in liquid crystal shutters can be prepared by mechanically entrapping the liquid crystals in the micropores of a plastic or glass sheet or by evaporation of water from a polymer emulsion containing liquid crystals.

More commonly, PSLC cells are made by preparing a mixture of synthetic monomer, photoinitiator, and liquid crystal and then photopolymerizing the preparation. Prior to photopolymerization, the homogeneous mixture of liquid crystal and monomer is placed between glass cell walls spaced about 10 microns apart. The solution is then exposed to ultraviolet light to form a film. As the film forms, the liquid crystals undergo a phase separation from the polymer. Polymer dispersed liquid crystals (PDLCs) made according to this method include dispersions of sub-micron sized droplets of liquid crystal in a polymer matrix. In the absence of an electric field, the directors of the liquid crystal are randomly oriented. The directors of the liquid crystal are the preferred molecular orientations of the liquid crystal mesophase, which can range from very ordered to very disordered (e.g., randomly oriented). When the directors are randomly oriented, the PDLCs appear light scattering and transmit little light. The refractive index of the polymer is chosen to match as closely as possible the refractive index of the liquid crystal such that upon application of an electric field, refractive index discontinuities are eliminated and the shutter becomes transparent. PDLCs having high polymer concentrations (>˜20 wt-%), however, display a hazy appearance at oblique incident angles even when the electric field is on. At large enough viewing angles, the perceived mismatch between the effective index of refraction of the liquid crystal and the refractive index of the polymer makes the film appear essentially opaque.

To provide wider viewing angles, smaller percentages of polymer can be used with cholesteric or chiral nematic liquid crystals. When the electric field is off (“field-off state”), the polymer disrupts the long range order of the liquid crystals, thus creating refractive index discontinuities and a light scattering appearance. Application of the electric field causes the liquid crystal directors to homeotropically align with the electric field (i.e., the long axis of the liquid crystals aligns perpendicular to the cell wall). This eliminates the refractive index discontinuities and makes the liquid crystal polymer film transparent. In both high and low percentage polymer films, the addition of a polymer to the liquid crystal gives rise to shutters that scatter light in the absence of an electric field.

PSLCs, however, have a number of disadvantages. The monomer/photoinitiator combination used to form the PSLC cells exists in a metastable state that is maintained only through careful handling. Unwanted exposure to heat and light, for example, can cause premature polymerization that ruins the shutter. The extra processing steps and careful handling needed to prepare polymer-based light scattering shutters can dramatically increase costs and reduce manufacturing yield.

Multistable liquid crystal shutters (also referred to as liquid crystal displays or LCDs) can be prepared without the need for polymers, thus avoiding their additional manufacturing costs (see, e.g., U.S. Pat. No. 5,453,863). However, LCDs operated according to the '863 patent also have shortcomings that limit the effectiveness of the displays at shuttering light from transient events, such as those associated with pulsed lasers or photographic flash lamps. According to the '863 patent, a sufficiently low electric field pulse applied to the device described therein results in a light scattering state that is milky-white in appearance, corresponding to a focal conic texture. This focal conic texture, though, permits transmission of a significant portion of incident light at the cell gap typically employed in LCDs. Moreover, if an electric field high enough to homeotropically align the liquid crystal is applied, the focal conic texture will only form if the electric field is turned off slowly. Thus, the focal conic texture is not an effective texture to shutter fast transient events.

Furthermore, if the electric field is removed quickly, LCDs of the '863 patent relax to a planar reflecting texture. The planar reflecting texture reflects light at a maximum wavelength corresponding to λ=np, where λ is the wavelength, n is the average refractive index of the liquid crystalline material (n=(nₑ+nₒ)/2 where nₑ is the extraordinary refractive index and nₒ is the ordinary refractive index), and p is the pitch (which is the distance required for the director of a chiral liquid crystal to rotate 360 degrees). The time required for the liquid crystal to reconfigure from a homeotropic texture to a planar texture can be several seconds, which for many applications is too slow. Although surfactants, such as those described in U.S. Pat. No. 5,661,533, have been developed to improve the transition time, they typically do not address the limited spectral reflectivity of the liquid crystal in cases where blocking across a broad spectral range (e.g., the visible spectrum) is important.

A liquid crystal shutter that can switch very quickly between a transparent state and a strongly light scattering state (which scatters light across a broad visible spectral range) would be advantageous in a number of different applications, including 3D multiplanar volumetric display systems (i.e., systems in which images actually occupy a definite volume of three-dimensional space).

Many known 3D display systems disadvantageously require specialized eyewear or headgear such as goggles, helmets, or both. Such eyewear is often bulky and uncomfortable and can cause eye fatigue. Furthermore, this eyewear reduces the perception of viewing an actual 3D image.

A known 3D volumetric display system reflects light from a laser source off of a rapidly spinning multifaceted mirror onto a rapidly spinning projection screen. Such rapidly spinning components, however, can be relatively large and thus need to be carefully balanced to avoid vibration and possibly catastrophic failure. Additionally, the size, shape, and orientation of 3D volume elements (i.e., voxels) within the display depends on their location from the shaft that rotates the mirrors, resulting in display resolution that is dependent on the position of the viewer.

Other types of 3D volumetric display systems, such as multiview autostereoscopic displays, are also known. Such multiview autostereoscopic displays, however, do not display a field of view that is continuous in all directions as the viewer moves with respect to the display device.

In view of the foregoing, it would be desirable to provide 3D display devices that have high resolution/voxel count.

It would also be desirable to provide 3D display devices that do not have the mechanical and optical limitations of known devices described above.

It would further be desirable to provide 3D display devices that include a liquid crystal shutter that can switch very quickly between a transparent state and a strongly light scattering state.

### SUMMARY OF THE INVENTION

It is an object of this invention to provide 3D display devices that have high resolution/voxel count.

It is also an object of this invention to provide 3D display devices that do not have the mechanical and optical limitations of known devices described above.

It is further an object of this invention to provide 3D display devices that include a liquid crystal shutter that can switch very quickly between a transparent state and a strongly light scattering state.

In accordance with the invention, transient light scattering shutters based on chiral liquid crystals are provided. The shutters switch very quickly between a highly transparent state and a very low transparent, highly scattering state. The shutters are optically clear when an electric field across the shutters is on (“field-on state”) and are scattering in the field-off state. When the electric field is quickly turned off, the shutters become strongly scattering (transmission <1%) for a fraction of a second before relaxing to a weakly scattering static state.

The invention also provides multi-planar volumetric displays that include a plurality of such transient light scattering shutters. These displays scatter light off of the plurality of shutters at preferably a video rate to generate 3D images. A multi-surface optical display device formed with the plurality of transient light scattering shutters advantageously provides for natural viewing, with substantially all of the depth cues associated with viewing a real object. This minimizes eye strain and permits viewing for extended periods of time without fatigue or bulky and uncomfortable eyewear or headgear.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 illustrates cross-sectionally an embodiment of a liquid crystal cell of a transient light scattering shutter according to the invention;

FIG. 2 illustrates a multi-planar volumetric display system according to the invention;

FIGS. 3(a)-3(b) illustrate graphically as a function of time the relationship between voltage and the transparent and scattering states of an embodiment of a transient light scattering shutter according to the invention;

FIGS. 4-6 illustrate graphically the transparency of an embodiment of a transient light scattering shutter as a function of voltage according to the invention;

FIGS. 7-10 illustrate successive displays of images that form a volumetric three-dimensional image on transient light scattering shutters according to the invention.

### Detailed DESCRIPTION OF THE INVENTION

The following terms and definitions are used herein:

“Chiral liquid crystal” refers to liquid crystals that have a chiral mesophase.

“Infrared” refers to radiation in the electromagnetic spectrum having a wavelength from about 700 nanometers to about 10 microns.

“Near-infrared” refers to radiation in the electromagnetic spectrum having a wavelength from about 700 nanometers to about 2.5 microns.

“Ultraviolet” or “UV” refers to radiation in the electromagnetic spectrum beyond the violet end of the visible spectrum, having a wavelength from about 4 to about 400 nanometers.

“Visible spectrum” refers to radiation in the electromagnetic spectrum that is visible to the human eye. The visible spectrum has a wavelength from about 400 nanometers to about 700 nanometers.

“Transient light scattering state” refers to an unstable, highly light scattering, liquid crystal texture formed by removing an electric field that causes the light scattering shutters of the invention to be transparent to incident light. The transient light scattering state is composed of microdomain textures, which are randomly oriented with respect to each other, and give rise to the highly light scattering appearance of the liquid crystalline material. Application of an electric field ends the transient light scattering state and erases the opacity of the liquid crystalline material.

The transmission percentage of a spectrum of light is given in terms of the total number of photons transmitted within the specified spectral range, not with respect to every wavelength within the spectral range.

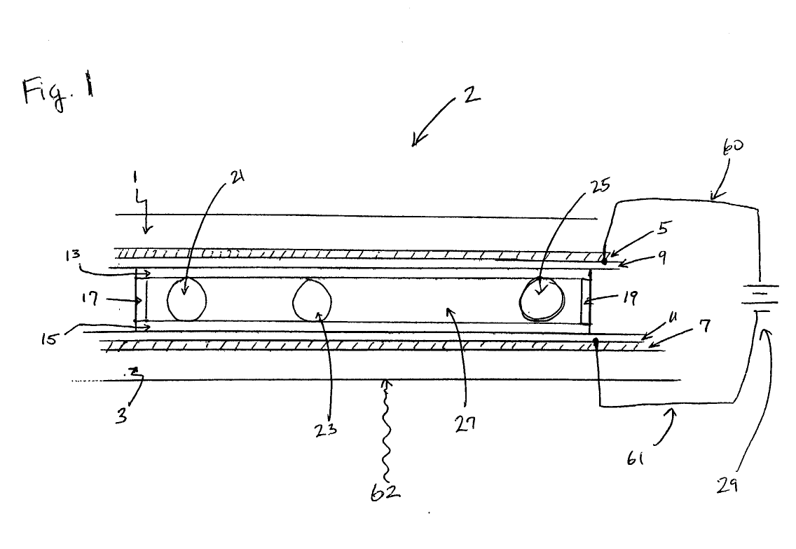

FIG. 1 shows a liquid crystal cell 2 of a light scattering shutter in accordance with the invention. Cell 2 includes two glass or plastic cell walls 1 and 3 whose inner surfaces are coated with a series of layers that include the following: transparent conducting layers 9 and 11; insulating layers 13 and 15; cell seals 17 and 19; spacers or alignment layers 21, 23, and 25; and a liquid crystalline light modulating material layer 27, which is preferably not polymer stabilized. In a particular embodiment, the liquid crystalline material is substantially polymer free. Insulating layers 13 and 15 prevent short circuits and are composed of, for example, silicon oxide. Cell seals 17 and 19 maintain cell integrity and enable vacuum filling. These seals can be composed of, for example, thermally cured epoxy.

Cell 2 preferably further includes barrier layers 5 and 7. Barrier layers 5 and 7 prevent migration of impurities from the glass into the transparent conductor and are composed of, for example, silicon oxide. Optional additional layers may include, for example, inorganic oxides such as hafnium oxide or magnesium dioxide, which can improve the cell's light transmission. Optional surface layers also can be applied to the cell to affect the liquid crystal directors or to alter the contrast, reflection, or switching characteristics of the cell. These optional surface layers may be rubbed, unrubbed, or otherwise untextured.

In general, the materials composing the cell layers should have appropriate refractive indices and thicknesses to minimize reflective losses within the cell.

Cell walls 1 and 3 can be any suitable glass or plastic substrate. The substrate material is chosen such that it has an index of refraction preferably matched to the underlying layers of the cell such that reflection and refraction of light are minimized. The exterior surfaces of cell walls 1 and 3 are preferably treated with anti-reflection (AR) layers, such as laminated films, solgel dip coatings, or evaporated dielectric oxides to further improve light transmission. The interior surfaces of the cell walls are also preferably treated with an index matching layer to minimize refractive index mismatch between the cell walls and adjacent layers. Additionally, or alternatively, the cell walls can be treated with a layer that limits selected wavelengths of light to alter the performance of the light scattering shutter. Moreover, a layer that limits light from, for example, the ultraviolet spectrum, may improve the stability of the light scattering shutter. In another embodiment, the cell walls have embedded within them one or more substances that absorb selected wavelengths of light.

Conducting layers 9 and 11 can be any suitable transparent conductive material that results in a uniformly applied electric field to the liquid crystal mixture. Typical conductors include, for example, indium tin oxide (ITO), other metallic oxides, or possibly organic conductors. These transparent conductive layers can be applied to the glass or plastic substrate by any suitable commercial method, such as evaporation or sputtering.

A refractive index difference between conducting layers 9 and 11 and cell walls 1 and 3 may produce unwanted reflections at the interfaces thereof. To reduce those unwanted reflections, additional layers of AR material may be optionally disposed on cell walls 1 and 3. For example, an AR layer having an optical thickness of about one quarter of a typical wavelength of light, such as about 76 nm, and having a refractive index approximately equal to \sqrt{n1×n2} (where n₁ is the refractive index of the substrate and n₂ is the refractive index of the conducting layer) can reduce the reflection at the substrate-conductive layer interface to very low levels. In particular embodiments, MgF₂ or solgel may be used to form the AR layer.

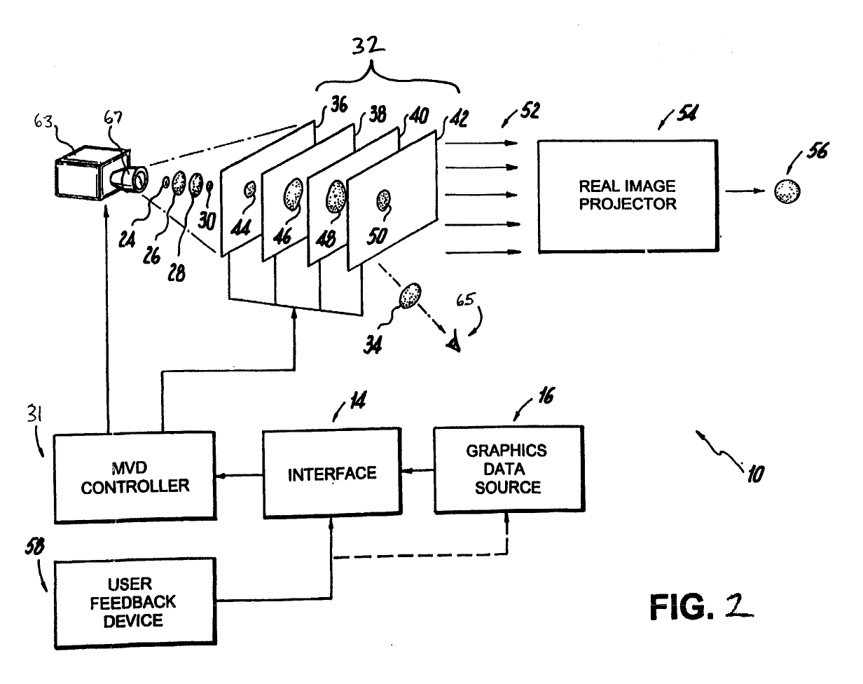

A voltage source 29 (e.g., from MVD controller 31 of FIG. 2) generates an electric field via conducting layers 9 and 11 between the cell walls of optical element 36 (FIG. 2). This causes the liquid crystals in liquid crystalline mixture 27 to align and transmit light 62 through optical element 36 with little or no scattering. Optical element 36 is thus substantially transparent. In one embodiment, optical element 36 in its transparent state preferably transmits greater than about 85% of the incident light from the visible spectrum.

Electrical conductors 60 and 61 are connected to transparent conducting layers 9 and 11 at the edges of the cell where layers 9 and 11 are exposed. Connections can be made via a number of techniques including but not limited to conducting epoxy, metallic tape with conducting adhesive, solder, organic conductors, or anisotropic conductors.

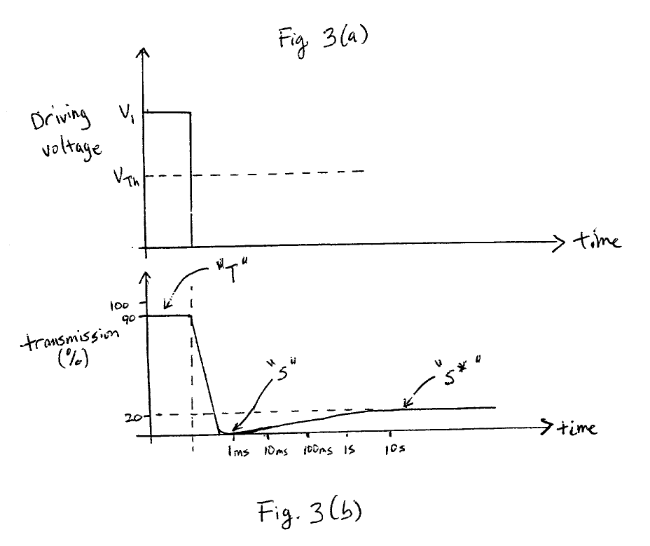

The optical scattering of the liquid crystalline material in a shutter of the invention is controlled by an electric field provided by voltage source 29, which is preferably capable of reversing its polarity. Apparently, the electric field untwists the chiral nematic or cholesteric liquid crystal molecules and homeotropically aligns the liquid crystal directors to transform the liquid crystals into a transparent state (denoted “T” in FIG. 3(b)). When the voltage is turned off, the liquid crystalline material forms microdomain textures (denoted “S” in FIG. 3(b)), which have a size on the same order of magnitude as the scattered light wavelength. Although the directors within each microdomain are ordered (i.e., short range order), they are disordered with respect to other microdomains (i.e., no long range disorder). This localized chiral domain formation is believed to contribute to the observed transient shuttering effect in light scattering shutters of the invention, as illustrated in FIGS. 3(b) and 4-6. During the transient light scattering state, the shutter of the invention strongly scatters incident light. In particular embodiments, the shutter preferably transmits less than about 1% of the incident light from the visible spectrum. More preferably, the transient light scattering state transmits less than about 0.5% of the incident light from the visible spectrum. In a more preferred embodiment, the shutter of the invention transmits less than about 0.1% of the incident light from the visible spectrum during the transient light scattering state. In another embodiment, the transient light scattering state scatters light from one or more of the following spectral ranges: the visible spectrum, the ultraviolet spectrum, the near-infrared spectrum, and the infrared spectrum.

The transient light scattering state is not stable when the electric field is off. After the voltage is turned off, the microdomains gradually coalesce, forming an equilibrium structure that is only weakly scattering (denoted “S*” in FIG. 3(b)). This diffuse light scattering texture permits transmission of a significant portion of the incident light.

If the voltage is turned on, however, the liquid crystalline material becomes transparent again. Preferably, when the voltage is turned back on, the voltage polarity is reversed. In one embodiment, the liquid crystalline material preferably transmits greater than 85% of the incident light each time it becomes transparent.

The planar reflecting texture (i.e., the “reflective state”) of the invention preferably reflects wavelengths outside the spectral range scattered by the transient light scattering state. The reflected wavelength of the liquid crystalline material while in the reflective state can be selected by appropriate adjustment of the pitch and refractive indices of the substances that compose the liquid crystalline material. In one embodiment, the selected reflected wavelength is preferably outside the visible region of the electromagnetic spectrum. If the pitch is selected, for example, such that the liquid crystalline material maximally reflects light wavelengths outside the visible spectrum, the liquid crystalline material in its reflective state will appear colorless and transmissive. In another embodiment of the invention, the selected maximum reflected wavelength is shorter than the visible spectrum (e.g., in the ultraviolet wavelength range). In a further embodiment, the selected reflected maximum wavelength is in the near-infrared range. In a more preferred embodiment, the selected maximum wavelength is between about 850 nanometers and about 1.4 microns.

Light modulating liquid crystalline material 27 preferably comprises a mixture of nematic liquid crystal having positive dielectric anisotropy and a chiral dopant in an amount sufficient to produce a desired pitch length. In another embodiment, light modulating liquid crystalline material 27 comprises cholesteric liquid crystals. The shuttering effect is expected to occur in some or all chiral liquid crystal mesophases, including for example smectic C* ferroelectric liquid crystals. Suitable chiral nematic, cholesteric, or smectic chiral textured liquid crystals are commercially available. The needed amount of liquid crystal and chiral dopant varies depending on the particular liquid crystal and chiral dopant used. Chiral dopant induces or enhances the helical twist of the liquid crystal molecules in the liquid crystalline mixture. As discussed in U.S. Pat. No. 6,217,792, incorporated herein by reference, the pitch of the liquid crystalline material is approximately inversely proportional to the concentration of the chiral dopant (p=(1/HTP)(1/c)), where c is the concentration of the chiral dopant and HTP is a proportionality factor representative of the helical twisting power (HTP) of the chiral dopant. Thus, the desired pitch can be obtained by selecting a chiral dopant with suitable helical twisting power or by controlling the concentration of the dopant in the liquid crystalline mixture, or both. The chiral dopant may be, for example, a cholesteric liquid crystal either alone or in combination with other chiral dopants.

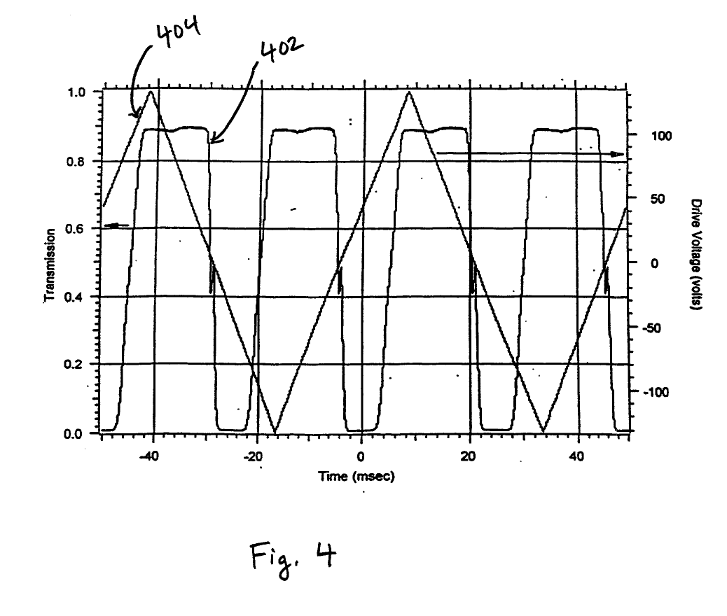

In a preferred embodiment, when the voltage is turned on beyond a certain threshold, the liquid crystalline material switches to a transparent state. While reversing the polarity of voltage source 29, the liquid crystalline material goes through a transient state, which strongly scatters light, before becoming transparent again as a result of the reversed-polarity electric field. As shown in FIGS. 3(a) and 4-5, the transient state becomes the most scattering when the voltage is approximately zero. FIG. 4 illustrates the transmission of light as a function of time using a triangular waveform with a 132-volt peak at 20 Hz.

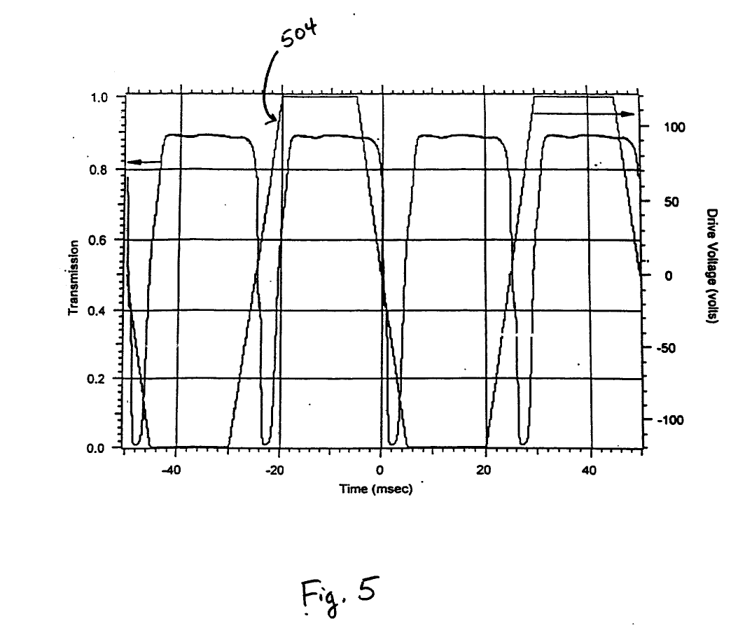

FIG. 5 illustrates the transmission of light with a truncated triangular waveform. In one embodiment, the electric field is preferably applied by an AC voltage with rms amplitude greater than or equal to the threshold voltage of the transient light shutter. More preferably, a DC bipolar voltage is applied to the shutter. In another embodiment, a unipolar voltage is applied to the shutter.

The threshold voltage needed to turn the transient shutter transparent depends on the liquid crystalline material and the thickness of the gap between the cell walls of the transient shutter. Typically, at least 10 volts per micron of spacing between the inner surfaces of the cell walls is needed to reach the threshold voltage.

The applied voltage can be any suitable waveform in which the voltage drops to zero to induce the aforementioned transient state. The waveform can be, for example, sinusoidal, triangular, truncated triangular, or square. Most preferably, the voltage reverses polarity each time after it drops to zero. The maximum frequency at which the voltage can be turned on and off to switch between transparent and transient scattering states is limited by the material response of the liquid crystalline material. This is easily determined by those of ordinary skill in the art.

Spacers or alignment layers 21, 23, and 25 (FIG. 1) separate the transparent electrodes. The spacers are preferably chemically inert, transparent, substantially insulating, and maintain a uniform cell gap. They are preferably made of glass or polymers in the shape of, for example, beads or rods. If made of polymer, the material can be, for example, cellulose acetate, cellulose triacetate, cellulose acetate butyrate, polyurethane elastomers, polyethylene, polycarbonates, polyvinylfluoride, polytetrafluorethylene, polyethylene terephthalate, polybutylene terephthalate, or mixtures thereof. Alternatively, polymer blends or co-extruded polymers can be used to make the spacers. The spacers define the thickness of liquid crystalline material 27 in cell 2 and are preferably in the range of about 4 to about 20 microns thick. More preferably, the spacers are about 10 to about 15 microns thick.

In some shutters according to the invention, transition speeds between the transparent and scattering states appear to vary with shutter temperature. For example, heating the shutter (using nematic liquid crystal and ZLI-4572 chiral additive) from about 29° C. to about 65° C. reduces the transition time from the transparent state to the scattering state from about 1.56 msec to about 0.34 msec, and reduces the transition time back to the transparent state from about 2.73 msec to about 0.45 msec. A reduction in viscosity of the liquid crystal is believed to contribute to the decreased transition times. In one embodiment, the conducting layer, made from ITO for example, is slightly resistive, and can be used to heat the liquid crystalline material. This embodiment has the advantage of providing intimate contact between the heater and liquid crystalline material as well as uniform spatial heating of the liquid crystalline material.

Switching speeds may also be influenced by or controlled with additives in the liquid crystal layer. For example, the additives described in WIPO Publication WO 98/53028 of Kent Displays, Inc., are expected to lower viscosity and reduce switching times. Other known additives, such as surfactants, should provide similar effects.

By using voltage source 29 synchronized to an external device such as a laser, video projector, photographic flash lamps, strobe light, etc., the transient light scattering shutter can shutter or reflect light for video rate displays, 3D volumetric displays, ultrafast optical shutters, etc. As described in U.S. Pat. No. 6,100,862, incorporated herein by reference, a plurality of individual transient light scattering shutters may be combined to form a multi-surface optical device that can be integrated into a multiplanar volumetric display (MVD) system. Each transient light scattering shutter functions as an individual optical element of the multi-surface optical device. Multiplanar optical element (MOE) device 32 (FIG. 2) converts a series of two-dimensional images from image projector 63 into a 3D volume image.

In such a multi-surface optical system, an optical element controller controls the optical translucency of the liquid crystal elements, such that a single liquid crystal element is in an opaque light-scattering state in order to receive and display an image from the image projector. The other remaining liquid crystal elements are in their transparent state. The optical element controller successively causes each liquid crystal element to be in the opaque light-scattering state in order to receive and display a respective image, thus generating a volumetric 3D image with 3D depth. To have the set of images appear as one continuous image, the optical element controller, in one embodiment, rasters through successive liquid crystal elements at a high rate, at least that of a standard video rate (e.g., 30 Hz or faster).

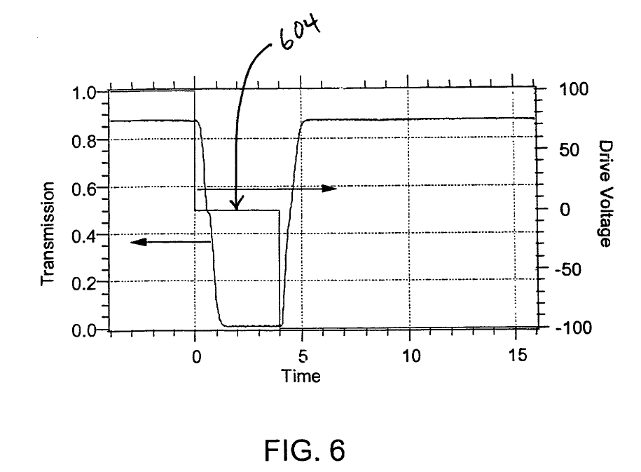

The optical element controller is preferably a waveform generator. In one embodiment, the optical element controller is a bipolar waveform generator. FIG. 6 shows an example of the transparency of a shutter as a function of voltage 604 when operated with a bipolar waveform generator. In one embodiment using the bipolar waveform generator, the first transparent conducting layer of the transient light scattering shutter is held at zero volts while the second transparent conducting layer is brought to a positive voltage sufficient to cause the shutter to become transparent. To transform the shutter to a transient light scattering state, the voltage is removed from the second transparent conducting layer and held at zero volts for a period of time, typically about 2 milliseconds. The voltage on the second transparent conducting layer is then reversed to a negative voltage sufficient to cause the shutter to become transparent. During the next scattering cycle, the voltage on the second transparent conducting layer is again brought to zero volts and held before returning to a positive voltage. Operated in this manner, the average voltage applied to the cell is zero.

In an alternative embodiment using a bipolar waveform generator, the voltage applied to the cell is positive. The first transparent conducting layer is held at zero volts while the second transparent conducting layer is brought to a positive voltage sufficient to cause the shutter to become transparent. To transform the shutter into the transient light scattering state, the voltage on the first transparent conducting layer is increased until equal to the voltage on the second conducting layer such that the voltage difference across the shutter is zero. To return the shutter to transparency again, the voltage on the second conducting layer is brought to zero volts, resulting in a reversal of the polarity of the electric field applied to the shutter. To cause the shutter to become scattering a second time, the voltage on the first conducting layer is brought to zero volts, resulting in a zero electric field across the shutter. To return the shutter to transparency once more, the voltage on the second conducting layer is brought back to a positive voltage. Again, the average voltage applied to the cell is zero. This alternative embodiment advantageously requires only a single voltage supply and applies an identical square voltage waveform to each side of the shutter. Furthermore, the duration of the transient light scattering state can be advantageously controlled, within the limits of the liquid crystalline material microdomain lifetime, by controlling the time delay between applications of voltage to each side of the conducting layer.

In another embodiment, the optical element controller is a unipolar waveform generator that operates as follows: the first transparent conducting layer of the transient shutter is held at zero volts while the second transparent conducting layer is brought to a positive voltage sufficient to cause the shutter to become transparent. To transform the cell into a transient light scattering state, the voltage is removed from the second transparent conducting layer and held at zero volts for a period of time, typically about 2 milliseconds. To return the cell to the transparent state, the voltage on the second transparent conducting layer is returned to the original positive voltage.

FIG. 2 shows a multiplanar volumetric display (MVD) system 10 that generates 3D volumetric images in accordance with the invention. That is, the 3D images occupy a definite and limited volume of 3D space, and thus exist at the location where the images appear. Such 3D images are true 3D, as opposed to an image perceived to be 3D because of an optical illusion created by, for example, stereographic methods.

Three-dimensional images generated by MVD system 10 preferably have very high resolution and are displayed in a large range of colors. The 3D images therefore have the characteristics associated with viewing a real object. For example, such 3D images may have both horizontal and vertical motion parallax or lookaround, allowing a viewer 65 to move and yet still receive visual cues that maintain the 3D appearance of the images.

Advantageously, a viewer 65 needs no eyewear such as stereographic visors or glasses to view the 3D image. Furthermore, the 3D image has a continuous field of view both horizontally and vertically, with the horizontal field of view equal to about 360° in certain display configurations. Additionally, the viewer can be at any arbitrary viewing distance from MVD system 10 without loss of 3D perception.

The image to be viewed in three dimensions is converted by MVD controller 31 into a series of two-dimensional image slices each at a particular depth through the 3D image. The frame data corresponding to the image slices are then rapidly output from the high speed image buffer of MVD controller 31 to image projector 63.

Prior to transmission of the image data to image projector 63, MVD controller 31, or alternatively graphics data source 16, preferably performs 3D anti-aliasing on the image data to smooth the features of displayed 3D image 34. This reduces or eliminates any jagged lines in depth between, for example, parallel planes aligned orthogonal to a z-axis. Such jagged lines result from display pixelization caused by the inherently discrete voxel construction of MOE device 32 with optical elements 36, 38, 40, and 42, which are aligned in x-y planes normal to a z-axis. As data corresponding to image slices 24, 26, 28, and 30 are generated, an image element may appear near an edge of a plane transition (e.g., optical elements 36 and 38). To avoid a jagged transition at a specific image element, slices 24 and 26, for example, are both preferably generated such that each of respective images 44 and 46 includes the specific image element. Thus, the image element is shared between both planes formed by optical elements 36 and 38, which softens the transition and allows 3D image 34 to appear more continuous. The brightness of an image element on consecutive optical elements is varied in accordance with the location of the image element in the image data.

Image projector 63 has optics 67 for projecting two-dimensional slices 24, 26, 28, and 30 of a 3D image at a high frame rate and in a time sequential manner to MOE device 32. The two-dimensional slices are projected to generate a first volumetric 3D image 34, which appears to viewer 65 to be present within the space of MOE device 32. MOE device 32 includes a plurality of optical elements 36, 38, 40, and 42 which, under the control of MVD controller 31, receive respective slices 24, 26, 28, and 30, which are displayed as two-dimensional images 44, 46, 48, and 50. During each frame rate cycle, one optical element receives and displays a respective slice. The number of slices generated by MVD controller 31 is equal to the number of optical elements. That is, each optical element represents a unit of depth resolution of a generated and displayed volumetric 3D image.

The overall display of each of slices 24, 26, 28, and 30 on respective optical elements 36, 38, 40, and 42 occurs at a sufficiently high frame rate (e.g., rates preferably greater than about 35 Hz) such that viewer 65 perceives a single continuous volumetric 3D image 34, and not a series of individual two-dimensional images. Thus, for example, images 44, 46, 48, and 50 may each be a different cross-section of a sphere, and the generated image will appear as a single 3D sphere to viewer 65. This image can be advantageously viewed directly without a stereographic headset or any other equipment needed by the viewer.

In alternative embodiments, images 44, 46, 48, and 50 can be generated such that an overall image has a mixed 2D and 3D appearance, such as, for example, 2D text below a 3D sphere. An application of this 3D display with a 2D backdrop may be a graphical user interface (GUI) control pad. The GUI control pad would appear to viewer 65 to comprise a 2D virtual flat screen GUI, such as that provided by Microsoft Windows@, and 3D graphical elements appearing on that virtual flat screen display.

Volumetric 3D image 34 is viewable within a range of orientations. Furthermore, emitted light 52 from MOE device 32 is preferably further processed in accordance with this invention by a “real” image projector 54 to generate volumetric 3D image 56. Image 56 appears to be substantially the same image as volumetric 3D image 34, but floating in space at a distance from MOE device 32. Real image projector 54, or alternatively a floating image projector, can be a set of optics, such as mirrors and lenses, for collecting light 52 emitted from MOE device 32 and for re-imaging 3D image 34 out into free space. Real image projector 54 is preferably a high definition volumetric display (HDVD), which includes a conventional spherical or parabolic mirror to produce a signal viewing zone located on an optical axis of MOE device 32. For example, real image projection systems can be the apparatus described in U.S. Pat. Nos. 5,552,934 and 5,572,375, each of which is incorporated herein by reference.

Because both volumetric 3D images 34 and 56 appear to viewer 65 to have volume and depth, and optionally also color, MVD display system 10 can be adapted for virtual reality and haptic/tactile applications, such as teaching surgery (see the example below). Real image projector 54 allows floating 3D image 56 to be directly accessible for virtual interaction. MVD system 10 preferably includes a user feedback device 58 that receives hand movements from viewer 65 using a hand-held device (e.g., forceps) to attempt to manipulate either of images 34 and 56. Such hand movements are translated by user feedback device 58 into control signals that are conveyed via interface 14 to MVD controller 31. MVD controller 31 responds by modifying one or both of images 34 and 56 to appear as if responding to the movements of viewer 65.

Another application of MVD system 10 includes a force feedback interface that can be used as a surgical simulator and trainer. In such a simulator, a user can see and feel 3D virtual anatomy, such as an animated beating heart and its reactions to virtual prodding by the user. This simulator could be used to obtain certification as a surgeon, practice innovative new procedures, or even perform remote surgery over the Internet, for example, using Internet communication protocols. Tactile effects may thus be combined with animation to provide real-time simulation and interaction with users of 3D images generated by MVD system 10.

In another embodiment, MOE device 32 includes a stack of glass transient light scattering shutters as optical elements, which are separated by either glass, plastic, liquid, or air inter-stack spacers. Alternatively, the optical elements may be plastic or other substances having various advantages, such as lightweight construction. The inter-stack spacers are preferably combined with the cell walls in an optically continuous configuration to eliminate reflections at internal interfaces. The cell walls and spacers of the liquid crystal display can be optically combined by either optical contact, index matching fluid, or optical cement. Alternatively, the inter-stack spacers can be replaced by liquid such as water, mineral oil, or index matching fluid. Such liquids can be circulated through an external chilling device to cool MOE device 32. Also, such inter-stack liquid-spaced shutters may be transported and installed empty to reduce their overall weight. The spacing liquid can then be added after installation.

The spacing distance between optical elements may be constant, or alternatively may be variable such that the depth of MOE device 32 is greatly increased without increasing the number of optical elements. For example, because viewer 65 loses depth perception with increased viewing distance, the optical elements positioned farther from viewer 65 may be spaced farther apart. For example, logarithmic spacing may be used, in which the spacing between optical elements increases with distance from viewer 65. This advantageously enables one to create a physically deeper display without the need to use more optical elements at increasing distance from the viewer.

If AR layers are used, the spacing material between optical elements may be removed to leave air or a vacuum between each element, thus reducing the overall weight of MOE device 32. Such AR layers may be vacuum deposited, evaporated, or sputtered. Alternatively, the AR layers may be applied by spin coating, dip coating, or meniscus coating with solgel.

In another embodiment of the invention, only one optical element of MOE device 32 is in the highly scattering state at any given time. As image projector 63 projects slices 24, 26, 28, and 30 at a high rate through a projection cycle, with one slice emitted per cycle, the scattering plane is rapidly rastered through the depth of MOE device 32 to form an effectively variable depth projection screen. The remaining transparent optical elements permit viewer 65 to see the displayed image from received image slices 24, 26, 28, and 30.

As shown in FIGS. 7-10, successive frame data is fed from MVD controller 31 to image projector 63 to generate images 82, 84, 86, and 88. In one embodiment of the invention, images 82, 84, 86, and 88 are displayed sequentially. Any changes that are sought in the 3D image are made by sequentially refreshing all of the optical elements in MOE device 32. Such sequential frame ordering may be sufficient in marginal frame rate conditions, such as frame rate displays of about 32 Hz for still images and of about 45 Hz for images displaying motion.

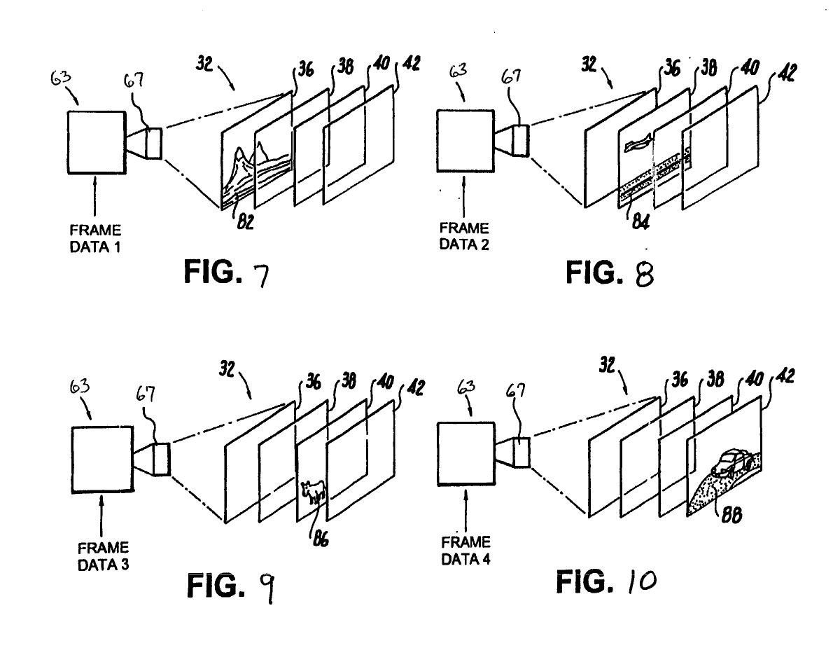

MVD controller 31 synchronizes the switching of optical elements 36, 38, 40, and 42 such that optical element 36 is opaque as image 82 is emitted thereon (FIG. 7), optical element 38 is opaque as image 84 is emitted thereon (FIG. 8), optical element 40 is opaque as image 86 is emitted thereon (FIG. 9), and optical element 42 is opaque as image 88 is emitted thereon (FIG. 10). MVD controller 31 preferably introduces a delay between feeding each set of frame data (i.e., the image data that together form the 3D image) to image projector 63 and causing a given optical element to be opaque such that image projector 63 has enough time during the delay to generate respective images 82, 84, 86, and 88 from the sets of frame data.

While one optical element is opaque and displays a respective image thereon, the remaining optical elements are transparent. Thus, image 82 on optical element 36 (FIG. 7) is visible through at least optical element 38. Similarly, image 84 (FIG. 8) is visible through at least optical element 40, and image 86 (FIG. 9) is visible through at least optical element 42. Because images 82, 84, 86, and 88 are displayed at a high rate by image projector 63 onto respective optical elements 36, 38, 40, and 42, which are switched between opaque and transparent states at a high rate, images 82, 84, 86, and 88 appear as a single volumetric 3D image 34.

To form a continuous volumetric 3D image 34 without perceivable flicker, each optical element 36, 38, 40, and 42 receives a respective image and is switched to an opaque state preferably at a frame rate greater than about 35 Hz. Accordingly, to refresh and update the entire 3D image, the frame rate of image projector 63 should be greater than about N×35 Hz, where N is the number of optical elements in MOE device 32. For a stack of 50 transient light scattering shutters forming MOE device 32, each having an individual optical element frame rate of 40 Hz, the overall frame rate of image projector 63 should be greater than about 50×40 Hz=2000 Hz. High performance and high quality volumetric 3D imaging by MVD system 10 may require frame rates on the order of 15 kHz.

In another embodiment, changes to the 3D image may be made by refreshing the optical elements of MOE device 32 in a semi-random order to lower image jitter and to reduce motion artifacts. Each optical element is still only updated once each time the MOE device displays all the slices composing the 3D image. Such semi-random plane ordering includes multi-planar interlacing in which even numbered planes are illuminated with images, and then odd numbered planes are illuminated with images. This increases the perceived volume rate without increasing the frame rate of image projector 63.

MOE device 32 maintains the image resolution originally generated in image projector 63 to provide high fidelity 3D images. Liquid crystal optical elements 36, 38, 40, and 42 are haze-free in the transparent state and switch rapidly between the transparent state and the opaque, scattering state. Moreover, the scattering state efficiently and substantially scatters light from image projector 63 to form an image.

In a preferred embodiment, the liquid crystal shutter is planar and rectangular but, alternatively, it can be curved or have other shapes, such as cylindrical. For example, cylindrical liquid crystal shutters can be fabricated by techniques such as extrusion and may be nested within each other.

Most of the panel's volume and weight are associated with the glass substrates, which contribute to a potentially bulky and heavy MOE device 32, particularly as the transverse size and number of panels increase. Liquid crystal panels made of plastic is one way to decrease weight. Very thin plastic substrates, for example, can be fabricated continuously and at very low cost by a roll-to-roll process. By using such thin plastic, MOE device 32 may also be collapsible when not in operation. This advantageously allows MVD system 10 to be portable.

Optical elements 36, 38, 40, and 42 may also include other inorganic materials in addition to or instead of liquid crystal technology, such as an ITO layer organically applied by spin or dip coating.

In an embodiment of the invention, MOE device 32 includes 10 liquid crystal panels and is preferably about 5.5 inches (14 cm) long by about 5.25 inches (13.3 cm) wide by about 2 inches (4.8 cm) in depth. Image projector 63 includes an acousto-optical laser-beam scanner that has a pair of ion lasers to produce red, green, and blue light, which is modulated and then scanned by high frequency sound waves. The laser scanner is capable of vector scanning 166,000 points per second at a resolution of 200×200 points. When combined with the 10-panel MOE device 32 operating at 40 Hz, MVD system 10 produces 3D images with a total of 400,000 voxels. A color depth of 24-bit RGB resolution can be obtained, with an image update rate of preferably about 1 Hz. Using real image projector 54, a field of view of about 1000×450 (horizontal×vertical) can be attained.

In another embodiment, MOE device 32 includes 12 liquid crystal panels and is preferably about 6 inches (15.2 cm) long by about 6 inches (15.2 cm) wide by about 3 inches (7.7 cm) in depth. In this embodiment, image projector 63 includes a pair of Texas Instruments® video projectors, designed to operate in field-sequential color mode to produce grayscale images at a frame rate of about 180 Hz. By interlacing the two projectors, a “single” projector is effectively formed with a frame rate of about 360 Hz. This produces 12-plane volumetric images at a rate of about 30 Hz. The transverse resolution attainable is 640×480 points. When combined with this 12-plane MOE device 32 operating at about 30 Hz, MVD system 10 produces gray 3D images with a total of 3,686,400 voxels. A color depth of 8-bit grayscale resolution is obtained with an image update rate of about 10 Hz. Using real image projector 54, a field of view of about 1000×450 can be attained.

In a further embodiment, MOE device 32 includes 50 liquid crystal panels and is preferably about 15 inches (38.1 cm) long by about 13 inches (33.0 cm) wide by about 10 inches (25.4 cm) in depth. When combined with this 50-plane MOE device 32 operating at about 40 Hz, MVD system 10 produces 3D images with a total of 13,107,200 voxels. A color depth of 24-bit RGB resolution is obtained, with an image update rate of about 10 Hz. Using real image projector 54, a field of view of about 1000×450 can be attained. With such resolution and a non-interlaced volume rate of 40 Hz, MVD system 10 advantageously has a display capability equivalent to a conventional monitor with a 20-inch (50.8 cm.) diagonal.

In a still further embodiment, optical elements of the invention have a transverse resolution of 1280×1024 and a depth resolution of 256 planes. The system preferably operates in a depth interlaced mode in which alternate panels are updated at about 75 Hz, with the complete volume refreshed at a rate of about 37.5 Hz. Such interlacing provides a higher effective volume rate without having to increase the frame rate of image projector 63.

In yet another embodiment, MOE device 32 includes 500 liquid crystal panels and is preferably about 33 inches (84 cm) long by about 25 inches (64 cm) wide by about 25 inches (64 cm) in depth. The liquid crystal panels preferably have a depth resolution and a transverse resolution of 2048×2048 pixels, which could produce 3D images with greater than 2 billion voxels. With such resolution and size of display, the MOE device 32 in this embodiment has a display capability equivalent to a conventional monitor with a 41-inch (104 cm) diagonal.

MVD system 10 advantageously controls and produces occlusion, which is the obstruction of light from background objects by foreground objects. A limited form of occlusion, called computational occlusion, can be produced by picking a particular point of view and then simply not drawing surfaces that cannot be seen from that point of view. This improves the rate of image construction and display. When viewer 65 attempts to look around foreground objects, however, the parts of background objects that were not drawn are not visible. In an embodiment of the invention, MVD system 10 compensates for the lack of occlusion by interspersing optical elements in a scattering state to create occlusion by absorbing background light. In another embodiment, guest-host PDLCs may be interspersed within the array of transient light scattering shutters to create and control occlusions. In guest-host PDLCs, a dye is mixed with the liquid crystal molecules. The appearance of the dye in the PDLC can be masked or made to appear depending on whether the liquid crystalline material is transparent.

MVD system 10 advantageously exhibits little or no contrast degradation caused by ambient illumination. Real image projector 54 and MOE device 32 are preferably enclosed in a housing that reduces the amount of ambient light reaching MOE device 32, thus preventing contrast degradation.

Alternatively, contrast degradation can be reduced in accordance with the invention by increasing the illumination from image projector 63 in proportion to the ambient illumination and by installing an absorbing plastic enclosure around MOE device 32 to reduce the image brightness to viewable levels. The ambient light must pass through the absorbing enclosure twice to reach viewer 65—once on the way in and again after scattering off the optical elements of MOE device 32. In contrast, the light from image projector 63, which forms the images, only passes through the absorbing enclosure once on the way to viewer 65, and thus has a lower loss of illumination.

In another embodiment of the invention, the chiral nematic liquid crystal mixture consists of 72% by weight nematic liquid crystal E44 (Merck) and 28% by weight cholesteric liquid crystal CB 15 (Merck). This mixture is placed in a 14-micron thick cell with a silicon oxide barrier and insulator layer and no alignment layer. The static transmission of the cell is about 20.7% at a wavelength of about 632.8 nm.

FIG. 4 shows the amount of light transmission 402 of such a cell at 632.8 nm when driven by a triangular wave 404 with a peak voltage of 132 volts at a frequency of 20 Hz. The cell has periods of high transparency with light transmission of approximately 90%. This is comparable to the 92% light transmission expected of ordinary glass without AR layers. The cell also has periods of very low transparency with transmission less than 0.1%. The duration of the low transmission period is determined by the rate at which the drive voltage decreases to zero volts.

Truncated triangular wave 504 of FIG. 5 allows adjustment of both the repetition rate and the duration of the low transmission period. The rate can be controlled by adjusting the periodicity of the waveform, while the duration can be controlled by manipulating the slope of the voltage drop to zero. The maximum period of time that the shutters of the invention can maintain a desired low transmission percentage is limited by the length of time that the transient microdomains in the shutters persist. If a very low transmission percentage is required (i.e., high opacity), as many microdomains as possible should be in the shutters. However, even in that case, duration of the very low transmission percentage will be very short (e.g., 2-10 ms), because of the short-lived nature of the microdomains. Thus, decreasing the voltage over a long period of time may not be effective in sustaining that very low transmission level. Alternatively, if a higher low transmission percentage is acceptable, fewer microdomains are needed to scatter light. Thus, in that case, a slower decaying voltage will prolong the duration of that low transmission percentage.

Another embodiment of the invention combines 95% by weight nematic liquid crystal E44 (Merck) and 5% by weight chiral additive ZLI-4572 (Merck). This mixture is placed in a cell with a 14-micron cell gap and no alignment layers. The resulting transient shutter has a static light transmission of about 3.8% and a transient light transmission of about 0.04% when driven to the scattering state by triangular waveform 504. The light transmission of the transparent state is about 86.4%.

Thus it is seen that transient light scattering shutters and 3D volumetric display systems using such shutters are presented. One will appreciate that the present invention can be practiced by other than the described embodiments, which are presented for purposes of illustration and not of limitation. Numerous modifications and substitutions can be made without departing from the spirit of the invention. For example, instead of using planar optical elements such as flat panel liquid crystal display shutters, curved optical elements can be used in a manner as set forth above. Accordingly, the present invention is limited only by the claims which follow.

We claim:

1. A transient light scattering shutter comprising:
first and second substrates;
a liquid crystalline material disposed between said first and second substrates, said material comprising a chiral liquid crystal; and
a voltage source coupled to said material and operative to provide:
a first electric field across said material to form a first transparent state,
a second electric field across said material to form a second transparent state, only one of said first and second electric fields being present across said material at a given time, and
a transition from one of said first and second electric fields to the other of said first and second electric fields by decreasing the voltage magnitude of one of said electric fields to zero volts and then increasing the voltage magnitude of the other of said electric fields from zero volts, said decreasing of voltage magnitude causing said material to form a transient light scattering state.

2. The transient light scattering shutter of claim 1 further comprising a heater operative to heat said liquid crystalline material.

3. The transient light scattering shutter of claim 1 further comprising a surfactant operative to increase transition speed between at least one of said first and second transparent states and said scattering state.

4. The transient light scattering shutter of claim 1 wherein said first and second substrates are comprised of a material selected from the group consisting of glass and plastic.

5. The transient light scattering shutter of claim 1 wherein said chiral liquid crystal is selected from the group consisting of cholesteric liquid crystal, nematic liquid crystal, and smectic chiral liquid crystal.

6. The transient light scattering shutter of claim 1 wherein said liquid crystalline material comprises a nematic liquid crystal and a chiral dopant.

7. The transient light scattering shutter of claim 1 wherein said liquid crystalline material is substantially polymer free.

8. The transient light scattering shutter of claim 1 wherein said chiral liquid crystal has a positive dielectric anisotropy.

9. The transient light scattering shutter of claim 1 wherein said voltage source comprises a DC bipolar voltage source.

10. The transient light scattering shutter of claim 1 wherein said second electric field has a polarity opposite said first electric field

11. A system operative to generate three-dimensional images comprising:
a multi-surface optical device comprising:
a plurality of transient light scattering shutters arranged in an array, each said shutter comprising first and second substrates and a liquid crystalline material disposed between said first and second substrates, said liquid crystalline material comprising a chiral liquid crystal, each said shutter having a transient light scattering state and a transparent state, and
a voltage source coupled to said shutters and operative to provide:
a first electric field across said material,
a second electric field across said material, only one of said first and second electric fields being present across said material at a given time, and
a transition from one of said first and second electric fields to the other of said first and second electric fields by decreasing the voltage magnitude of one of said electric fields to zero volts and then increasing the voltage magnitude of the other of said electric fields from zero volts; and
a first image projector operative to selectively project each image from a set of images onto a respective said shutter, said projected images together appearing as a three-dimensional image.

12. The system of claim 11 further comprising a heater to heat said material.

13. The system of claim 11 further comprising a surfactant operative to increase transition speed between at least one of said first and second transparent states and said scattering state.

14. The system of claim 11 further comprising a second image projector coupled to receive said projected images from said first image projector, said second image projector comprising optics to project said three-dimensional image at a location in space distant from said optical device, said projected three-dimensional image appearing to float in space.

15. The system of claim 11 further comprising a controller that comprises a computer processor, said controller operative to control the state of each said shutter, wherein one said shutter is in said transient light scattering state to receive and display said respective image, while the other said shutters are in said transparent state to allow viewing of said respective image on said one shutter.

16. The system of claim 15 wherein said controller is further operative to control said shutters during a plurality of cycles, each said shutter being in said transient light scattering state during a cycle different than the other said shutters.

17. The system of claim 11 wherein said first image projector projects each image of said set of images at a rate of no less than about 35 Hz.

18. The system of claim 11 wherein said shutters are equally spaced apart from each other.

19. The system of claim 11 wherein said shutters are logarithmically spaced apart from each other.

20. The system of claim 11 wherein said second electric field has a polarity opposite said first electric field.

21. A system operative to generate three-dimensional images comprising:
a multi-surface optical device comprising:
a plurality of transient light scattering shutters, each said shutter comprising first and second substrates and a liquid crystalline material disposed between said first and second substrates, each said shutter having a transient light scattering state and a transparent state, and
a voltage source coupled to said shutters and operative to apply first and second electric fields to said material, only one of said first and second electric fields having a non-zero value being present across said material at a given time;
a heater to heat said liquid crystalline material; and
a first image projector operative to selectively project each image from a set of images onto a respective said shutter, said projected images together appearing as a three-dimensional image.

22. A method of creating three-dimensional images using a transient light scattering shutter, said shutter comprising a liquid crystalline material, said material comprising a chiral liquid crystal, said method comprising:
applying a first electric field to said shutter to form a first transparent state;
decreasing said first electric field to zero volts to form a transient light scattering state; and
applying a second electric field to said shutter to form a second transparent state.

23. The method of claim 22 wherein said second electric field has a polarity opposite that of said first electric field.

24. The method of claim 22 further comprising heating said material to increase transition speed between at least one of said first and second transparent states and said scattering state.

25. The method of claim 22 wherein said liquid crystalline material further comprises a surfactant operative to increase transition speed between at least one of said first and second transparent states and said scattering state.

26. A method of creating three-dimensional images using a transient light scattering shutter, said method comprising:
transforming said shutter into a first transparent state;
transforming said shutter into a transient light scattering state; and
transforming said shutter into a second transparent state.

27. The method of claim 26 further comprising transmitting greater than about 85% of incident visible spectrum light while in said first transparent state.

28. The method of claim 26 further comprising transmitting less than about 1% of incident visible spectrum light while in said transient light scattering state.

29. The method of claim 26 further comprising transmitting less than about 0.5% of incident visible spectrum light while in said transient light scattering state.

30. The method of claim 26 further comprising transmitting less than about 0.1% of incident visible spectrum light while in said transient light scattering state.

31. The method of claim 26 further comprising transmitting greater than about 85% of incident visible spectrum light while in said second transparent state.

32. The method in claim 26 further comprising scattering light of a spectrum selected from the group consisting of the visible spectrum, the ultraviolet spectrum, the near-infrared spectrum, and the infrared spectrum while in said transient light scattering state.

33. The method of claim 26 further comprising heating said shutter to increase transition speed between at least one of said first and second transparent states and said transient light scattering state.

34. The method of claim 26 wherein said shutter comprises liquid crystalline material and surfactant operative to increase transition speed of said material between at least one of said first and second transparent states and said scattering state.

35. A method of creating three-dimensional images using a transient light scattering shutter, said shutter comprising a liquid crystalline material, said method comprising:
heating said material;
transmitting greater than about 85% of incident visible spectrum light;
switching from a first transparent state to a transient light scattering state;
transmitting less than about 1% of incident visible spectrum light while in said transient light scattering state;
switching from said transient light scattering state to a second transparent state; and
transmitting greater than about 85% of incident visible spectrum light while in said second transparent state.

36. The method of claim 35 wherein said heating comprises heating said material to about 65° C.

37. The method of claim 35 wherein said liquid crystalline material further comprises a surfactant operative to increase transition speed between at least one of said first and second transparent states and said scattering state.

38. The method of claim 35 wherein said switching from a first transparent state comprises switching from a first transparent state to a transient light scattering state in about 0.34 msec.

39. The method of claim 35 wherein said switching from said transient light scattering state comprises switching from said transient light scattering state to said second transparent state in about 0.45 msec.

40. A method of creating three-dimensional images using a transient light scattering shutter, said shutter comprising a liquid crystalline material disposed between first and second conducting layers, said material comprising a chiral liquid crystal, said method comprising:
applying zero voltage to said first conducting layer;
applying to said second conducting layer a positive voltage operative to make said material transparent;
decreasing said positive voltage at said second conducting layer to zero volts to cause said material to form a transient light scattering state;
holding said zero volts at said second conducting layer; and
decreasing the voltage at said second conducting layer from zero volts to a negative voltage operative to make said material transparent.

41. The method of claim 40 wherein said holding comprises holding said zero volts at said second conducting layer for about two milliseconds.

42. A method of creating three-dimensional images using a transient light scattering shutter, said shutter comprising a liquid crystalline material disposed between first and second conducting layers, said material comprising a chiral liquid crystal, said method comprising:
applying zero voltage to said first conducting layer;
applying to said second conducting layer a positive voltage operative to make said material transparent;
increasing said zero voltage at said first conducting layer to a positive voltage substantially equal to said positive voltage at said second conducting layer to cause said material to form a transient light scattering state;
decreasing said positive voltage at said second conducting layer to zero volts; and
decreasing said positive voltage at said first conducting layer to zero volts to cause said material to form a transient light scattering state.

43. A method of creating three-dimensional images using a transient light scattering shutter, said shutter comprising a liquid crystalline material disposed between first and second conducting layers, said material comprising a chiral liquid crystal, said method comprising:
applying zero voltage to said first conducting layer;
applying to said second conducting layer a positive voltage operative to make said material transparent;
decreasing said positive voltage at said second conducting layer to zero volts to cause said material to form a transient light scattering state;
holding said zero volts at said second conducting layer; and
increasing the voltage at said second conducting layer from zero volts to said positive voltage.

44. Apparatus for creating three-dimensional images using a transient light scattering shutter, said apparatus comprising:
means for transforming said shutter into a first transparent state;
means for transforming said shutter into a transient light scattering state; and
means for transforming said shutter into a second transparent state.

45. The apparatus of claim 44 further comprising means to increase transition speed between at least one of said first and second transparent states and said scattering state.

46. Apparatus for creating three-dimensional images, said apparatus comprising a liquid crystalline material, said apparatus comprising:
means for heating said material;
means for transmitting greater than about 85% of incident visible spectrum light;
means for switching from a first transparent state to a transient light scattering state in less than about 1.56 msec;
means for transmitting less than about is 1% of incident visible spectrum light while in said transient light scattering state;
means for switching from said transient light scattering state to a second transparent state in less than about 2.73 msec; and
means for transmitting greater than about 85% of incident visible spectrum light while in said second transparent state.
